(19) United States
(12) Patent Application Publication
(10) Pub. No.: US 2019/0274920 A1
(43) Pub. Date: Sep. 12, 2019

(54) AUTOMATIC CHEST COMPRESSION DEVICE TORSO SUPPORT PLATFORM

(71) Applicant: Hartwell Medical LLC, Carlsbad, CA (US)

(72) Inventor: Gary R. Williams, Carlsbad, CA (US)

(21) Appl. No.: 16/299,069

(22) Filed: Mar. 11, 2019

Related U.S. Application Data
(60) Provisional application No. 62/640,879, filed on Mar. 9, 2018.

(51) Int. Cl. A61H 31/00

(52) U.S. Cl. CPC A61H 31/006; A61H 2011/005; A61H 2203/0456; A61H 31/008

(57) ABSTRACT

A rigid back member of an automatic mechanical chest compression device is secured to a torso support platform. The torso support platform includes a main support strap immediately below where the rigid back member is secured to the torso support platform, and an upper support strap above where the rigid back member is secured to the torso support platform. The torso support platform tapers towards the top at approximately where a patient's shoulders are located when properly secured to the torso support platform. Additional straps may also be utilized, for example, shoulder straps extend over the shoulders of the patient and are secured to the torso support platform at a point below the patient's armpits, or straps that extend from the tapered section and secure to the automatic mechanical chest compression device.

### CROSS REFERENCE TO RELATED APPLICATIONS

This patent claims the benefit of U.S. Prov. Pat. App. No. 62/640,879 filed on Mar. 9, 2018, the entirety of which is hereby incorporated by reference.

### BACKGROUND OF THE INVENTION

Field of the invention: This invention relates to the general field of medical devices, and more specifically toward a torso support platform for use with an automatic mechanical chest compression device.

Cardiopulmonary resuscitation (CPR) is an emergency procedure that combines chest compressions often with artificial ventilation in an effort to manually preserve intact brain function until further measures are taken to restore spontaneous blood circulation and breathing in a person who is in cardiac arrest.

Automatic chest compression devices perform mechanical chest compressions when effective manual CPR is not possible. The survival rate of cardiac arrest victims may be significantly dependent on effective CPR. Such effective CPR may not be available, for example, when qualified personnel are unavailable, when qualified personnel need to move a patient up or downstairs or to an awaiting ambulance, or when qualified personnel become too fatigued to continue CPR. An automatic chest compression device provides extended CPR with minimal interruptions when fatigue, insufficient personnel, or patient transport may prohibit effective CPR.

Certain professionals believe that patients in cardiac arrest receiving CPR should be positioned at a 20-35 degree angle for certain periods of time during the resuscitation effort. This angle may result in better perfusion for the patient and hopefully better results for cardiac arrest victims to walk out of the hospital with little to no neurological deficits. However, compressions at this range of angles are often difficult to deliver manually. Moreover, proper positioning of an automatic chest compression device while it is operating is more difficult at this range of angles as well.

Automatic chest compression devices work well with stationary patients, but these devices have the potential to move when a cardiac arrest patient needs to be moved to a rigid or soft fabric stretcher, up or down an incline, or loaded into an ambulance.

Thus there has existed a long-felt need for an apparatus for use with an automatic chest compression device that restricts or prevents movement of the automatic chest compression device from the desired location on the patient's sternum, and enables proper use of the automatic chest compression device at a wide range of angles, including at inclinations of 20-35 degrees.

### SUMMARY OF THE INVENTION

The current invention provides just such a solution by having a torso support platform for use with an automatic chest compression device.

In certain embodiments, a rigid back member of an automatic chest compression device is secured to a torso support platform. The torso support platform includes a recessed area that conforms to the dimensions of the rigid back member of the automatic chest compression device. The torso support platform has a retention strap that securely affixes the rigid back plate of the automatic chest compression device to the torso support platform. The torso support platform includes a main support strap immediately below where the rigid back member of the automatic chest compression device is secured to the torso support platform. The torso support platform tapers towards the top at approximately where a patient's shoulders are located when properly secured to the torso support platform. At or around this tapered section, shoulder straps are connected to the torso support platform. These shoulder straps extend over the shoulders of the patient and are secured to the torso support platform so as to restrict the forward movement of the patients' shoulders. A secondary strap that can be adjusted along the length of the shoulder strap connects the two shoulder straps together. Additional straps may also be utilized, for example, that extend from the tapered section and secure to the automatic chest compression device.

In other certain embodiments, a rigid back member of an automatic chest compression device is secured to a torso support platform. The torso support platform includes a recessed area that accommodates the rigid back member of the automatic chest compression device. As a subset of these embodiments, the torso support platform may have the recessed area conform to the dimensions of the rigid back member of the automatic chest compression device to provide a more secure placement of the rigid back member. The torso support platform has a retention strap, also referred to as a band or a panel, that securely affixes the rigid back plate of the automatic chest compression device to the torso support platform. The torso support platform includes a main support strap immediately below where the rigid back member of the automatic chest compression device is secured to the torso support platform. A second strap, or upper strap, is affixed to the torso support platform above where the rigid back member of the automatic chest compression device is secured to the torso support platform, and below the head support section. Additional straps may also be utilized, for example, to secure the patient to the torso support platform, to secure the rigid back plate to the torso support platform, or to otherwise secure the automatic chest compression device over the desired location of the patient's sternum.

It is a principal object of the invention to provide a torso support platform for use with an automatic chest compression device that secures the automatic chest compression device in place over a patient's chest.

It is another object of the invention to provide a torso support platform for use with an automatic chest compression device that enables use of the automatic chest compression device at an angle, that is, non-parallel to the ground.

It is a further object of this invention to provide an automatic chest compression device with torso support platform for providing automatic chest compressions to a patient at an angle, for example, of between 20 and 35 degrees.

As used herein, the term “strap” may refer to one or more bands of fabric or webbed material, including both a single continuous strap as well as a plurality of discreet straps secured together to functionally act as a single strap. Likewise the term “straps” may refer to a singular strap, for example, where each end of the strap is connected to one or more other components.

Certain embodiments of the current disclosure include a torso support platform for use with an automatic chest compression device comprising a main body and a head support section, where the head support section is narrower than the main body, where the main body comprises a lower strap and an upper strap, where the main body further comprises a band, where the band has a first end permanently attached to the main body, and where the band has a second end that is releasably attached to the main body. The torso support platform further comprises a tapered section between the main body and the head support section. The main body further comprises a recessed section that accommodates a rigid back support of the automatic mechanical chest compression device. The second end of the band is releasably attached to the main body by a hook and loop fastener. The torso support platform further comprises two handles, one each on two opposing sides of the main body. The torso support platform further comprises three handles attached to the head support section. The head support section further comprises two head flaps, one each on two opposing sides of the head support section. Each head flap comprises a plurality of longitudinal sections. The width of the lower strap is different than the width of the upper strap, and more specifically, the lower strap is wider than the upper strap.

Furthermore, embodiments of the current disclosure include a method of securing an automatic chest compression device to a patient comprising the steps of: securing a rigid back support of the automatic chest compression device to a torso support platform, where the torso support platform comprises a main body and a head support section, where the main body comprises a lower strap and an upper strap, and where the main body further comprises a band, where the band secures the rigid back support of the automatic chest compression device to the torso support platform; securing a patient to the torso support platform by securing the lower strap and upper strap of the main body around the patient; and attaching a frame of the automatic chest compression device to the rigid back support of the automatic chest compression device. The method further comprises the step of operating the automatic chest compression device when the patient is horizontal at an angle of zero (0) degrees, at an angle of between twenty (20) and thirty-five (35) degrees from horizontal, or at any angle between zero (0) and thirty-five (35) degrees. The torso support platform further comprises two head flaps, where one of the two head flaps is secured to a first side of the head support section, and where the other of the two head flaps is secured to a second side of the head support section. The method further comprises the step of conforming the two head flaps to the patient's head. The torso support platform comprises five handles, one extending from a left side of a lower portion of the main body, one extending from a right side of the lower portion of the main body, one extending from the left side of the head support section, one extending from the right side of the head support section, and one extending from the top of the head support section. The method further comprises the step of placing the torso support platform beneath a patient using one or more of the handles.

Embodiments of the current disclosure may also include a torso support platform for use with an automatic chest compression device comprising a main body and a head support section, where the main body comprises a lower strap and an upper strap, where the width of the lower strap is different than the width of the upper strap, where the main body further comprises a band, where the band has a first end permanently secured to the main body, and where the band has a second end that is releasably secured to the main body. The main body further comprises a recessed section that conforms to the shape of a rigid back support of the automatic mechanical chest compression device. The torso support platform comprises three handles, one extending from a left side of a lower portion of the main body, one extending from a right side of the lower portion of the main body, and one extending from the head support section. The torso support platform further comprises two head flaps, where one of the two head flaps is secured to a first side of the head support section, and where the other of the two head flaps is secured to a second side of the head support section, where each head flap comprises a plurality of longitudinal sections.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. Furthermore, the use of plurals can also refer to the singular, including without limitation when a term refers to one or more of a particular item; likewise, the use of a singular term can also include the plural, unless the context dictates otherwise.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

There has thus been outlined, rather broadly, the more important features of the invention in order that the detailed description thereof may be better understood, and in order that the present contribution to the art may be better appreciated. There are additional features of the invention that will be described hereinafter and which will also form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a front view of a torso support platform according to selected embodiments of the current disclosure.

FIG. 2 is a front view of a torso support platform with a chest compression back plate secured thereto according to selected embodiments of the current disclosure.

FIG. 3 is a top perspective view of an automatic chest compression device secured to a torso support platform using shoulder support straps according to selected embodiments of the current disclosure.

FIG. 4 is a top perspective view of an automatic chest compression device secured to a torso support platform showing shoulder and additional support straps according to selected embodiments of the current disclosure.

FIG. 5 is a back view of a torso support platform according to selected embodiments of the current disclosure.

FIG. 6 is a front view of a torso support platform with head flaps and buckles secured for storage according to selected embodiments of the current disclosure.

FIG. 7 is a front view of a torso support platform with head flaps according to selected embodiments of the current disclosure.

FIG. 8 is a front view of a torso support platform with a rigid back support of an automatic chest compression device secured thereto according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

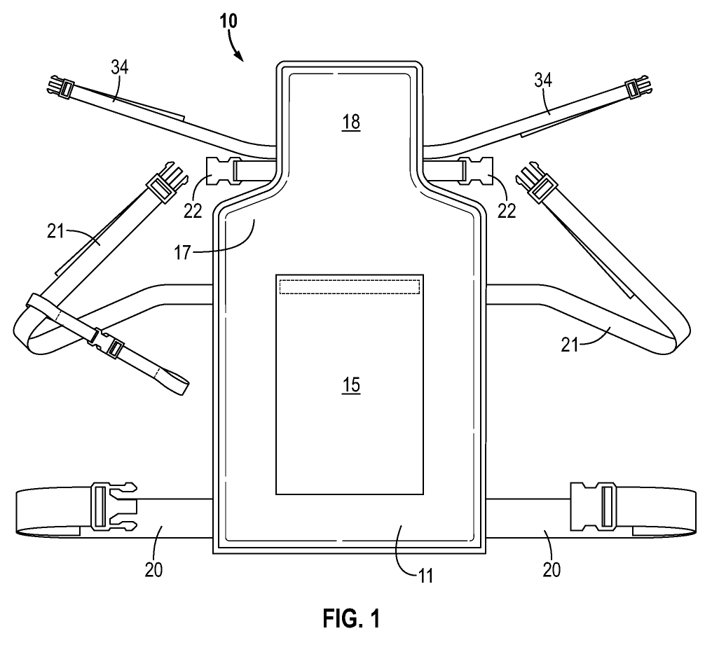

FIG. 1 is a front view of a torso support platform according to selected embodiments of the current disclosure. The torso support platform 10 includes a main body 11 with a band 15 for securing a rigid back support of an automatic chest compression device. A lower strap 20 is secured to and extends from the bottom of the main body 11. A second strap 21 is secured to and extends from the upper half of the main body 11, at or near where the top of the rigid back support of an automatic chest compression device is secured to the torso support platform 10. This second strap is the lower portion or secured to the shoulder straps 22, discussed in more detail below. The torso support platform 10 includes a tapered section 17 at or around where the shoulders of a patient would be located if secured to the torso support platform 10. The tapered section 17 ends at a head support section 18. Shoulder strap 22 is secured at or around the tapered section 17 or the bottom of the head support section 18. Shoulder strap 22 extends over the shoulders of a patient and connects to the torso support platform at a point below the patient's armpits. Support strap 34 may also be secured at or around the tapered section 17 or the bottom of the head support section 18 and connects to the main body of the automatic chest compression device.

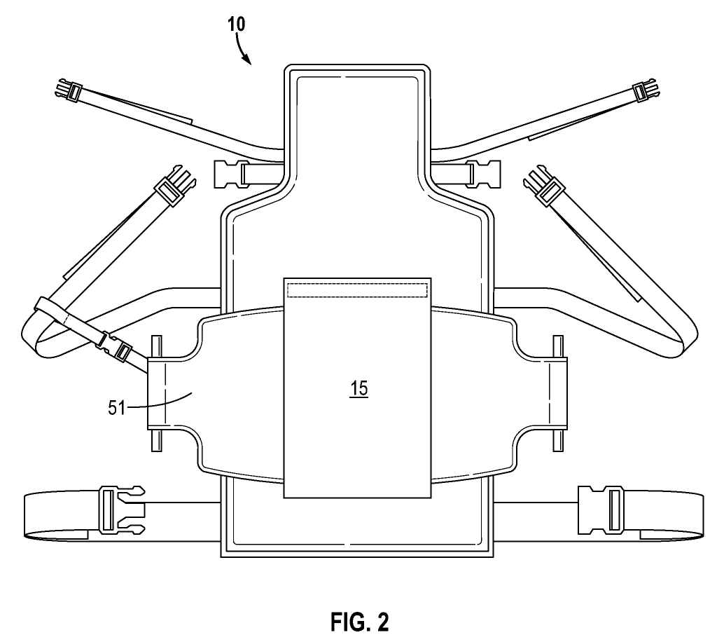

FIG. 2 is a front view of a torso support platform with a chest compression back plate or rigid back support of an automatic chest compression device secured thereto according to selected embodiments of the current disclosure. A rigid back support 51 for an automatic chest compression device is shown secured to the torso support platform 10.

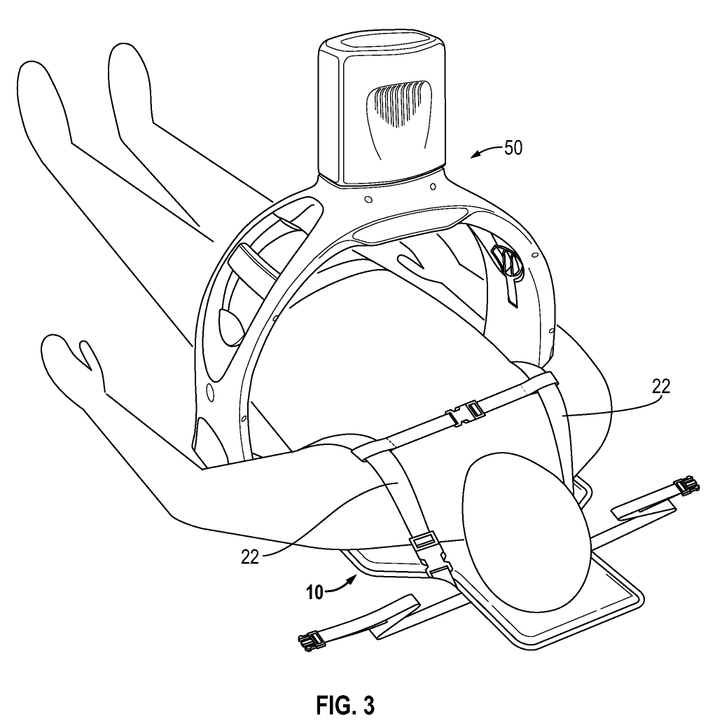

FIG. 3 is a top perspective view of an automatic chest compression device secured to a torso support platform showing shoulder strap 22 and additional support according to selected embodiments of the current disclosure. An automatic chest compression device 50 is shown secured to the torso support platform 10.

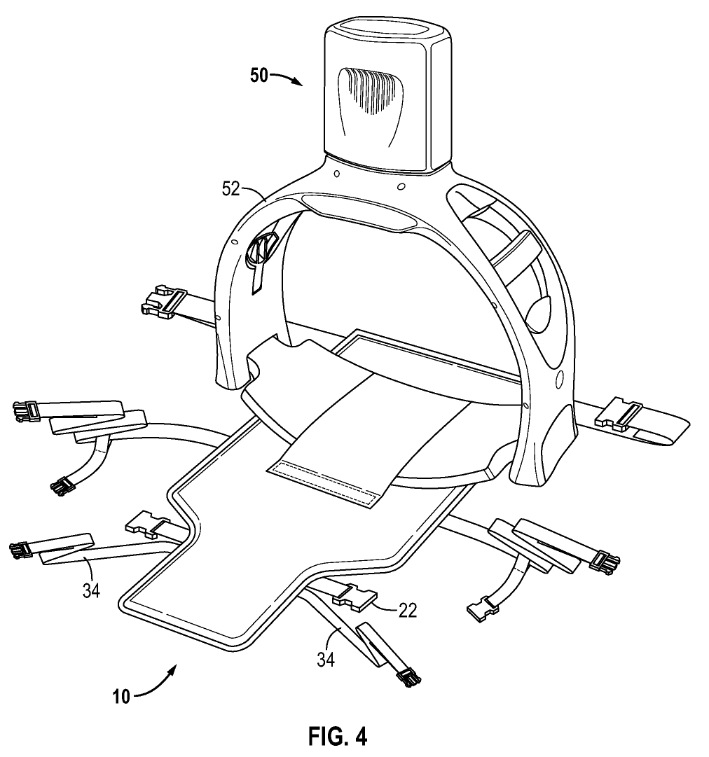

FIG. 4 is a top perspective view of an automatic chest compression device secured to a torso support platform showing shoulder and additional support straps according to selected embodiments of the current disclosure. An automatic chest compression device 50 is shown secured to the torso support platform 10. Shoulder strap 22 can be seen underneath support strap 34 which is connected to the frame 52 of the automatic chest compression device 50. A compression unit is affixed to or otherwise a part of the frame 52.

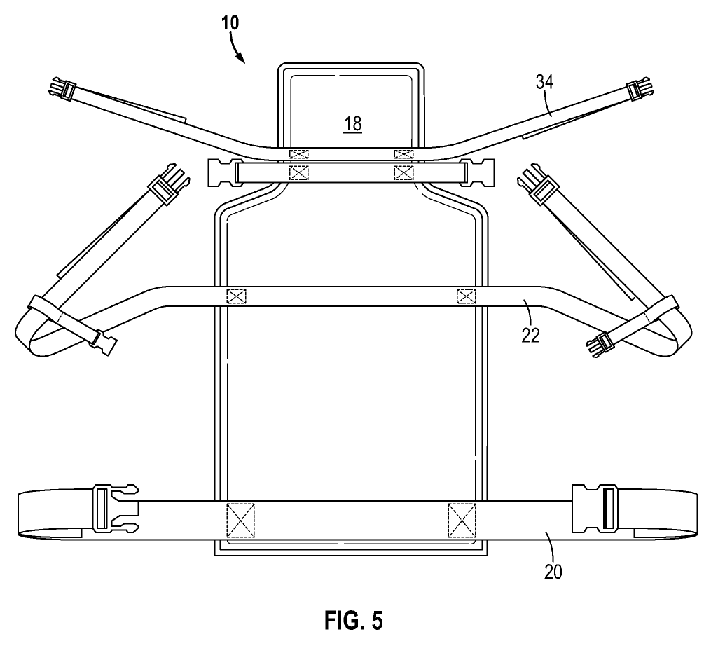

FIG. 5 is a back view of a torso support platform according to selected embodiments of the current disclosure. Lower strap 20, shoulder strap 22, and support strap 34 extend across the back of the torso support platform 10 and are secured thereto by, for example, stitching.

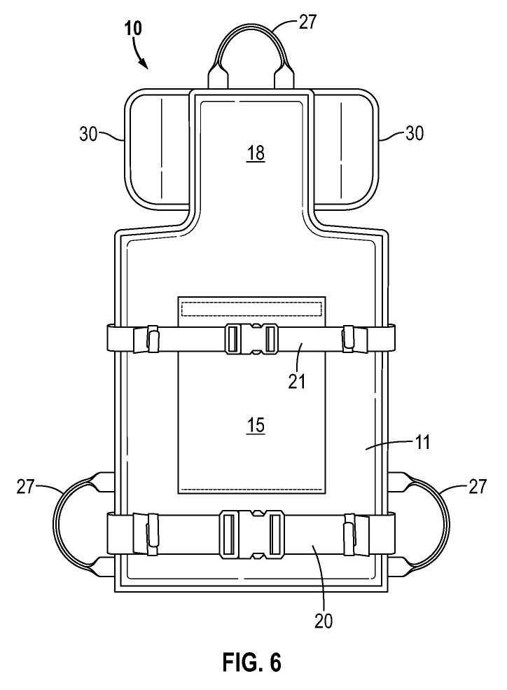

FIG. 6 is a front view of a torso support platform with head flaps and buckles secured for storage according to selected embodiments of the current disclosure. The torso support platform 10 has a main body 11 and a head support section 18. In this figure, the torso support platform has little or no tapered section between the main body 11 and head support section 18. A band 15 for securing a rigid back support of an automatic chest compression device (not shown in this figure) is located generally in the middle of the main body 11. There is a lower strap 20 secured to the lower portion of the main body 11, and a second (upper) strap 21 secured to the upper portion of the main body. Handles 27 are located on each side of the lower portion of the main body 11. There is also a handle 27 located at the top of the head section 18. Head flaps 30 are located on each side of the head section 18. The head flaps include a plurality of longitudinal sections that can bend or fold upwards on either side of the head of a patient lying upon the torso support platform.

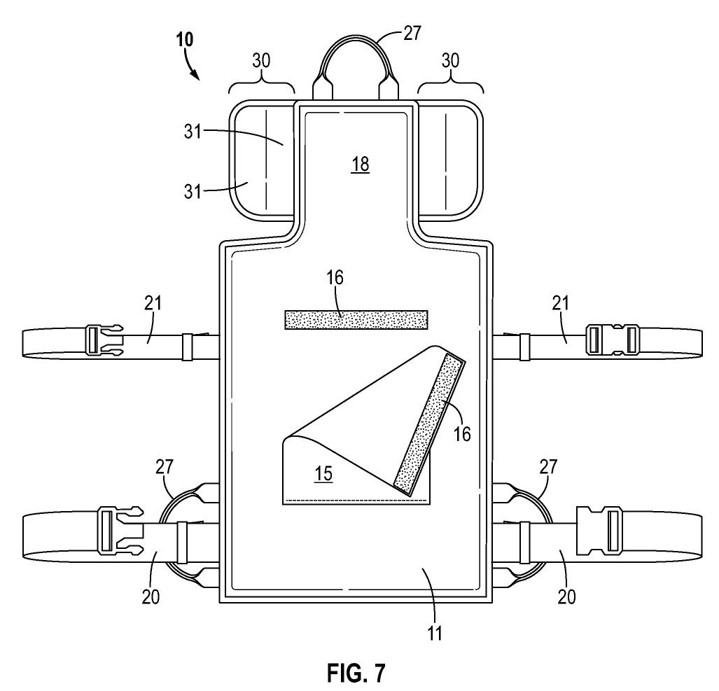

FIG. 7 is a front view of a torso support platform with head flaps according to selected embodiments of the current disclosure. Lower strap 20 and second (upper) strap 21 are each shown unbuckled and extending away from the main body 11 of the torso support platform 10. The band 15 has a lower end that is permanently affixed to the main body 11, for example, via stitching or a permanent adhesive. The band 15 has an upper end that is removably secured to the main body 11 via fastener 16, for example, a hook and loop fastener, snaps, or magnets. Handles 27 are located on each side of the lower portion of the main body 11. There is also a handle 27 located at the top of the head support section 18. Head flaps 30, located on each side of the head support section 18, each include a plurality of longitudinal sections 31, which in the embodiment shown in this figure, is two longitudinal sections 31 each.

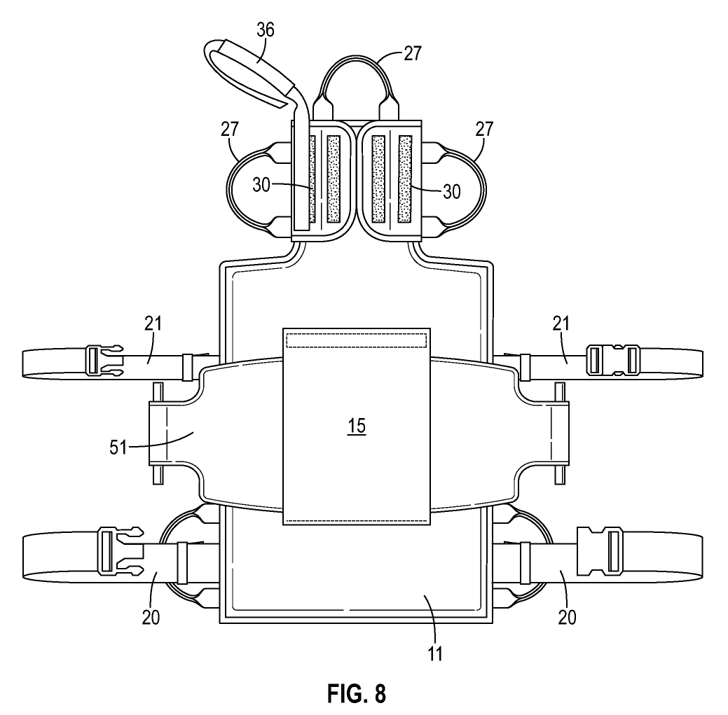

FIG. 8 is a front view of a torso support platform with a rigid back support secured thereto according to selected embodiments of the current disclosure. The rigid back member, also referred to as a rigid back support, of an automatic chest compression device is secured to the main body 11 of the torso support platform by a band 15. The head support section includes head flaps 30, with one head flap 30 attached to the left side of the head support section and one head flap 30 attached to the right side of the head support section. Also, there is a handle 27 attached to the left side of the head support section and a handle 27 attached to the right side of the head support section, such that there is a handle 27 attached to each side of the head support section. Furthermore, there is a handle 27 attached to the top of the head support section. Thus, for the embodiment shown in this figure, the torso support platform includes five handles in total. A head strap 36 is also shown, with one side secured to a head flap 30. For example, the head strap 36 may include two ends, each with a hook or loop fastener. The back surfaces of each head flap 30 may have a hook or loop fastener that mates with one of the ends of the hook or loop fastener of the head strap. A patient's head may be secured to the head section by conforming the head flaps 30 to the sides of the patient's head, positioning the head strap 36 over the patient's forehead, and securing each side of the head strap 36 to a head flap 30.

In certain embodiments, head flaps are two sewn longitudinal pockets that each have a stiffening element inside to provide a stable securement area for the head strap. Two segment flap design allows for conformance to a patients head and allows the head flaps to be folded over onto the head section for flatter, more compact storage. Head stabilization is beneficial when the patient is intubated or has any type of adjunct airway in place. This minimizes head movement which decreases the potential for the endotracheal tube or alternative airway device to be dislodged or move during transfer of the patient to the medical facility.

In other embodiments, the head flaps on either side of the head support section are vacuum splints. In such embodiments, movement of the patient's head is restricted by forming the head flap vacuum splint sections around the sides of the patient's head, and then evacuating the air within the head flap vacuum splint sections, thus increasing their rigidity and conforming to the patient's head.

In some embodiments, the torso support platform is made of plywood plates surrounded by canvas, vinyl, or other appropriate fabric or fabric-like material with webbing straps. Padding, such as foam, may be incorporated into the torso support platform for comfort and support. For example, the rigid back plate assembly may be comprised of ½ inch plywood with ½ inch rigid foam on top. The correct sized recess section in the ½ inch foam pad which is on top of the plywood back plate is an important feature along with the waist strap. Alternatively, the torso support platform may be made from molded plastic with webbing straps and with or without foam padding. Other embodiments of the current disclosure have a torso support platform made of composite materials.

Embodiments of the torso support platform and automatic chest compression device are described for use at an angle of 20-35 degrees; however, the same components may nonetheless work at any angle from negative 20 to positive 90 degrees, and potentially beyond this range.

Certain embodiments provide for a head support section that is narrower than what is shown in the figures discussed above.

Shoulder straps have been described herein that go from the back of the back support plate by the patient's shoulders to the sides or back of the torso support platform at a point below the patient's armpits. Alternatively, the torso support platform may not require such straps to hold the patient's shoulder girdle in place on the torso support platform.

Support straps have been described herein that go from the back of the back support plate by the patient's shoulders to the automatic chest compression device. Alternatively, the torso support platform may not require such straps to hold the automatic chest compression device in place patient's shoulder girdle in place on the back support plate.

The handles secured to the torso support platform are made sufficiently long to allow for a user wearing fire gloves to easily grasp the handles. There is a handle at the top edge of the head support section to allow for better control and easy placement of the torso support platform under the patient, particularly when an unconscious patient is lifted or pulled up by his or her arms to allow the torso support platform to be slid under the patient from the head end of the patient.

Other embodiments of the current disclosure include a torso support platform with four handles. One handle is located on each side of the lower portion of the main body, and one handle is located on each side of the head support section. For example, such a torso support platform is similar to that as shown in FIG. 8, except there is no handle extending from the top of the head support section.

The straps may include a dual adjusting buckle so that straps are adjustable from both sides of each respective buckle. Retainer straps may be utilized to hold the strap material (that is, the lower strap and second strap) in place when the torso support platform is stored. Strap webbing may be accordion folded with the retainer straps, which can be secured together by hook and loop fasteners, for fast deployment at the scene of the cardiac arrest patient. In certain embodiments, the lower strap (the strap that is closer to the patient's waist) is two (2) inches in width, while the second strap (the strap that is closer to the patient's shoulders) is one and one-half (1.5) inches in width. This design reduces, if not eliminates, the possibility that the straps get mixed up or attached to the wrong strap. Moreover, colored webbing with buckles of a different color may also be used for identification purposes and/or to reduce or eliminate incorrect fastening of one strap to another.

The lower and second (upper) straps may be removable with the use of a tri-glide on each side of the torso support platform. Alternatively, the straps may be permanently affixed (that is, not removable) so that there is no chance of the torso support platform being stored away with a strap missing or undone on one side. Use of webbing that is a distinctly different color from the buckle and a strap color that is highly visible against a human's skin color no matter what their skin color reduces the potential for hospital staff to inadvertently cut the straps off the device.

Embodiments of the current disclosure also provide for a torso support platform that includes a strut support. The strut support may include one or more fixed length or extendable members that are affixed to the main body of the torso support platform by a hinge. The rotatably secured strut members lift part of the torso support platform away from the underlying surface. This can be useful for positioning the patient at an incline, particularly for extended periods of time.

Further embodiments of the current disclosure also include a molded torso support platform, for example, a blow or rotational molded rigid plastic torso support platform. In such an embodiment, the handles described herein may be molded directly into the main body and/or head support section. For example, the torso support platform maybe substantially rectangular, with certain openings molded into the lower portion of the main body for the lower handles, and then openings to the left and right sides of the head support section, and above the head support section, to form the three upper handles. The main body of the torso support platform may also have a recessed portion that conforms to the size and shape of the rigid back member of the automatic chest compression device. The recessed portion can be molded to create a friction fit with the rigid back member to provide a quick and efficient means, and potentially an alternative means, for securing the rigid back member to the torso support platform. Likewise, the recessed portion may include projections on its upper surface to create a snap fit for the rigid back member.

While various embodiments of the present invention have been described above, it should be understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be implemented to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

That which is claimed:

1. A torso support platform for use with an automatic chest compression device comprising
a main body and a head support section,
where the main body comprises a lower strap and an upper strap,
where the main body further comprises a band, where the band has a first end permanently attached to the main body, and where the band has a second end that is releasably attached to the main body.

2. The torso support platform of claim 1, wherein the main body further comprises a recessed section that accommodates a rigid back support of the automatic mechanical chest compression device.

3. The torso support platform of claim 1, further comprising a tapered section between the main body and the head support section.

4. The torso support platform of claim 1, wherein the second end of the band is releasably attached to the main body by a hook and loop fastener.

5. The torso support platform of claim 1, further comprising two handles, one each on two opposing sides of the main body.

6. The torso support platform of claim 1, further comprising three handles attached to the head support section, one each attached on two opposing sides of the head support section, and one attached to a top side of the head support section.

7. The torso support platform of claim 1, wherein the head support section further comprises two head flaps, one each on two opposing sides of the head support section.

8. The torso support platform of claim 7, wherein each head flap comprises a plurality of longitudinal sections.

9. The torso support platform of claim 1, wherein the lower strap is wider than the upper strap.

10. The torso support platform of claim 1, wherein the width of the lower strap is different than the width of the upper strap.

11. A method of securing an automatic chest compression device to a patient comprising the steps of:
securing a rigid back support of the automatic chest compression device to a torso support platform, where the torso support platform comprises a main body and a head support section, where the main body comprises a lower strap and an upper strap, and where the main body further comprises a recessed section that accommodates the shape of the rigid back support of the automatic chest compression device;
securing a patient to the torso support platform by securing the lower strap and upper strap of the main body around the patient; and
attaching a frame of the automatic chest compression device to the rigid back support of the automatic chest compression device.

12. The method of claim 11, further comprising the step of
operating the automatic chest compression device when the patient is at an angle of between 20 and 35 degrees from horizontal.

13. The method of claim 11, wherein the torso support platform further comprises two head flaps, where one of the two head flaps is secured to a first side of the head support section, and where the other of the two head flaps is secured to a second side of the head support section.

14. The method of claim 13, further comprising the step of conforming the two head flaps to the patient's head.

15. The method of claim 11, wherein the torso support platform comprises five handles, one extending from a left side of a lower portion of the main body, one extending from a right side of the lower portion of the main body, one extending from a left side of the head support section, one extending from a right side of the head support section, and one extending from a top side of the head support section.

16. The method of claim 15, further comprising the step of placing the torso support platform beneath the patient using one or more of the handles.

17. A torso support platform for use with an automatic chest compression device comprising
a main body and a head support section,
where the main body comprises a lower strap and an upper strap, where the width of the lower strap is different than the width of the upper strap,
where the main body further comprises a band, where the band has a first end permanently secured to the main body, and where the band has a second end that is releasably secured to the main body.

18. The torso support platform of claim 17, wherein the main body further comprises a recessed section that conforms to the shape of a rigid back support of the automatic mechanical chest compression device.

19. The torso support platform of claim 17, wherein the torso support platform comprises five handles, one extending from a left side of a lower portion of the main body, one extending from a right side of the lower portion of the main body, one extending from a left side of the head support section, one extending from a right side of the head support section, and one extending from a top side of the head support section.

20. The torso support platform of claim 17, wherein the torso support platform further comprises two head flaps, where one of the two head flaps is secured to a first side of the head support section, and where the other of the two head flaps is secured to a second side of the head support section, where each head flap comprises a plurality of longitudinal sections.
